(19) United States
(12) Patent Application Publication
(10) Pub. No.: US 2009/0183705 A1
(43) Pub. Date: Jul. 23, 2009

(54) Hot spark injection system for diesel engines to promote complete combustion

(76) Inventor: George J. Coates, Wall, NJ (US)

Correspondence Address: CLIFFORD G. FRAYNE, 136 DRUM POINT RD, SUITE 7A, BRICK, NJ, 08723, US

(21) Appl. No.: 12/321,269

(22) Filed: Jan. 21, 2009

Related U.S. Application Data
(60) Provisional application No. 61/011,614, filed on Jan. 22, 2008.

(51) Int. Cl. F02B 1/14

(52) U.S. Cl. 123/143 A

(57) ABSTRACT

A spark injection system for an internal combustion engine for the detonation and combustion of remaining fuel/air mixture within the cylinder, the spark injection system introduces a pulsed electrical charge into the cylinder after the initial detonation when the piston is in a position of approximately five degrees after top dead center and the spark continues or is intermittently continued through the power stroke and through three quarters of the exhaust stroke, thus combusting the remaining fuel/air mixture and maintaining a higher temperature within the cylinder and alternatively the pulsed electrical charge is introduced during all four cycles of the cylinders operation.

### RELATED APPLICATIONS

Applicant claims the benefit of provisional application Serial No. 61/011,614, filed Jan. 22, 2008.

### BACKGROUND OF THE INVENTION

1. Field of the Invention

The present invention relates to internal combustion engines, and to the complete combustion of the fuel/air mixture within the cylinder head/combustion chamber, and has particular application to diesel engines.

2. Description of the Prior Art

Most internal combustion engines which operate with large cars and/or larger trucks and equipment operate on a four stroke system. The downward motion of the piston within the combustion chamber initiates the intake stroke in which the fuel/air mixture is introduced into the cylinder/combustion chamber. The upward movement of the piston from bottom dead center of the intake stroke initiates the compression stroke of the engine in which the fuel/air mixture is compressed at the top of the cylinder head. The power stroke occurs when the compressed fuel/air mixture is ignited either under compression in a diesel engine, or by an instantaneous spark in a conventional engine causing the piston head to move downwardly within the cylinder transferring a rotational force to the crank shaft, which in turn transfers the torque to a gear box or transmission to a drive shaft, and ultimately to the drive wheels. The final phase of the four stroke process is the exhaust stroke in which the piston moves upwardly within the cylinder/combustion chamber evacuating spent gases from the cylinder so that the intake stroke can be initiated when the piston completes the exhaust stroke.

In gasoline engines, the fuel/air mixture is ignited by means of an instantaneous external spark ignition system. In diesel engines, the fuel/air mixture is compressed to a ratio that creates enough heat to detonate the homogeneous charge without the assistance of an external spark ignition system. However, in the diesel engine particularly, after the detonation, the piston moves rapidly downwardly within the cylinder and the combustion cools and not all of the fuel is burned or combusted, especially when the engine is running at very high RPM's or is turbocharged. As a result, large amounts of unburned fuel is pumped out through the exhaust during the exhaust stroke, which is recognized in the atmosphere as small particles which are considered harmful emissions. It is therefore desired to improve the combustion within the diesel engine so as to obtain a more complete combustion of the fuel in the fuel/air mixture which is contained in the cylinder and which is ignited under compression, realizing that this application may still have application to internal combustion engines of the spark ignition type.

### OBJECTS OF THE INVENTION

An object of the present invention is to provide for a novel spark injection system for internal combustion engines, and in particular, for diesel engines, to insure the complete combustion of the fuel/air mixture within the cylinder.

A still further object of the present invention is to provide for a novel spark injection system for internal combustion engines, and in particular, diesel engines, in which a continuously pulsed electrical spark is provided to the cylinder during the intake, compression, power, and exhaust strokes.

A still further object of the present invention is to provide for a novel spark injection system for internal combustion engines, and in particular, diesel engines, in which a continuous pulsed electrical spark is provided to the cylinder during only a portion of the compression and exhaust stroke.

A still further object of the present invention is to provide for a novel spark injection system for internal combustion engines, and in particular, diesel engines, which provides a continuous pulsed, electrical spark to the cylinder during the downward portion of the power stroke and the upward portion of the exhaust stroke to fully ignite any fuel/air mixture not ignited at the top of the power stroke.

A still further object of the present invention is to provide for a novel spark injection system for internal combustion engines, and in particular, for diesel engines, in which a pulsed spark is introduced into the cylinder on the downward motion of the piston during the power stroke and continues during the upward movement of the piston during the exhaust stroke.

A still further object of the present invention is to provide for a novel spark injection system for an internal combustion engine, and in particular, for a diesel engine, in which the pulsed spark is either continuous or intermittent in an internal combustion engine of the type having a four stroke sequence of intake, compression, power and exhaust, a spark injection system for injecting a spark either continuously or intermittently into the cylinder during the downward motion of the piston during the power stroke and the upward motion of the piston during the exhaust stroke to ignite any fuel/air mixture remaining in the cylinder which was not combusted at the top of the compression stroke.

### SUMMARY OF THE INVENTION

A spark injection system for a diesel internal combustion engine for the detonation and combustion of fuel/air mixture within the cylinder, in one mode the spark injection system introduces a pulsed electrical charge into the cylinder after the initial detonation when the piston is in a position of approximately five degrees after top dead center and the spark continues or is intermittently continued through the power stroke and through three quarters of the exhaust stroke, thus combusting the remaining fuel/air mixture and maintaining a higher temperature within the cylinder and alternatively the pulsed electrical charge is introduced during all four cycles of the cylinders operation.

### BRIEF DESCRIPTION OF THE DRAWINGS

These and other objects of the present invention will become apparent, particularly when taken in light of the following illustrations wherein:

FIG. 1 is a side cross sectional view of the four strokes of an internal combustion diesel engine illustrating the introduction of the spark injection; and

FIG. 2 is a schematic diagram illustrating the spark injection system.

### DETAILED DESCRIPTION OF THE INVENTION

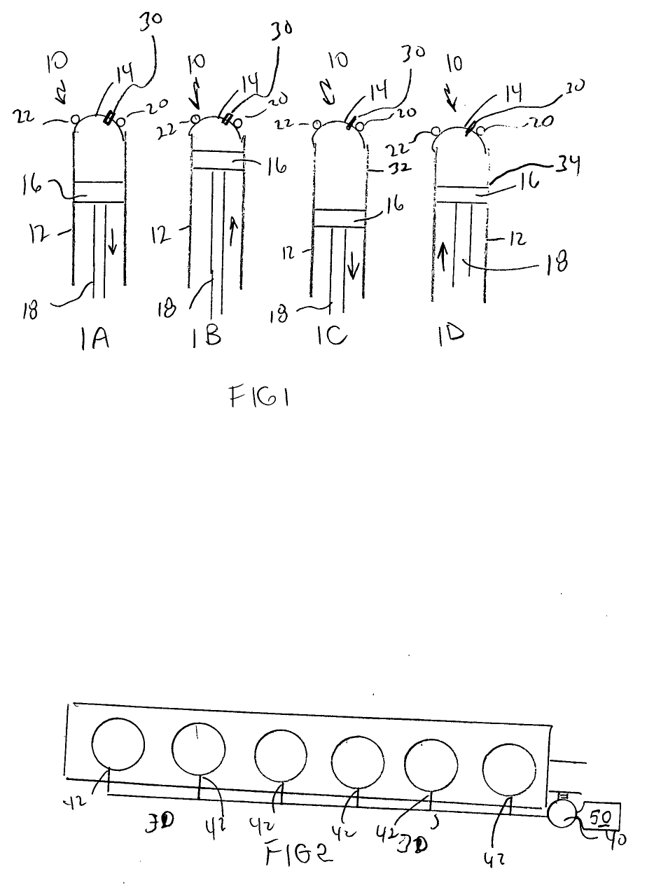

FIG. 1 is a cross sectional view of a single cylinder and piston arrangement which illustrates the four strokes which an internal combustion cylinder undergoes in order to provide power. The four strokes of the cylinder comprise the intake stroke 1A, the compression stroke 1B, the power stroke 1C, and the exhaust stroke 1D. FIG. 1 depicts a typical cylinder 10 of a diesel engine defined by a cylinder wall 12, a cylinder head 14, a piston 16, and connecting rod 18, which in turn would be connected to a crank shaft (not shown). An intake valve 20 and an exhaust valve 22 would be associated with each cylinder head.

In a diesel engine, high compression ratios serve to compress the fuel/air mixture at such a pressure that enough heat is generated to ignite the fuel/air mixture without the necessity of a spark plug as used in typical gasoline powered internal combustion engines. In the figure illustrated in FIG. 1, the piston 16 on the intake stroke 1A would be moving downwardly within the cylinder 10 with the intake valve 20 being open to allow the introduction of air into the cylinder. The piston 16 would eventually reach bottom dead center of the cylinder, namely its lowest reciprocating point. The piston 16 would then commence the compression stroke 1B, moving upwardly within the cylinder 10 compressing the air. As previously stated, in the diesel engine, the compression ratio is significantly high enough to cause the fuel/air mixture to ignite without the necessity of a spark plug. This pressure and heat would be achieved at a point proximate to top dead center, the highest reciprocating point of the piston 16 in 1B. The fuel would be injected into the cylinder immediately before the heat and pressure of combustion is achieved.

The ignition of the fuel/air mixture commences the power stroke 1C in which the rapid expansion of the ignited fuel/air mixture causes the piston 16 to reciprocate downwardly transferring the force of the ignition via the piston 16 and connecting rod 18 to the crank shaft and thence to a transmission and to the wheels of the vehicle.

The piston 16 then commences an upward reciprocating motion 1D causing the evacuation under pressure of the spent gases through the exhaust valve 22 which would now be fully open. At the top of the exhaust stroke 1D, the piston would then recommence the intake stroke 1A moving downwardly with the exhaust valve 22 having closed and the intake valve 20 having opened to allow the reintroduction of air.

Under perfect conditions all of the fuel/air mixture would be ignited at the top of the compression stroke 1B, however, this is rarely the case. The interior of the cylinder 10 cools rapidly as the piston 16 reciprocates downwardly in the power stroke 1C such that there is insufficient heat to ignite any remaining fuel/air mixture which fuel/air mixture would be exhausted to the atmosphere under the exhaust stroke 1D.

Applicant has fashioned a spark injection unit 30 within the cylinder head 14, which spark injection unit 30 is utilized in cooperation with the heat and pressure of combustion to ignite the initial fuel/air mixture completely. Typically a diesel engine detonates or fires at approximately 20 degrees before top dead center on the compression stroke 1B, which then initiates the power stroke 1C. The spark injection system 30 would introduce a pulsating spark into the cylinder in one of several manners at approximately 5 degrees after top dead center on 32 the power stroke 1C when the piston is reciprocating downwardly and this spark injection would either be a continuously pulsed spark introduced into the cylinder through the remainder of the power stroke 1C until the piston 16 reached bottom dead center of the power stroke and would be introduced during the exhaust stroke 1D until the exhaust stroke were approximately three quarters completed.

Ensuring the ignition of the entire fuel/air mixture maintains the temperature of the cylinder at a higher temperature for a longer period of time such that the system will reduce the harmful emissions, produce higher horsepower and higher torque, and lower the consumption of the fuel.

An alternative ignition protocol, which would simplify the timing aspects of the introduction of the electrical spark into the cylinder, would call for a continuous pulsating spark during the intake stroke 1A, the compression stroke 1B, the power stroke 1C, and the exhaust stroke 1D. This protocol would further insure complete combustion of any fuel/air mixture within the cylinder. Still further, this protocol would not affect and precombustion since the fuel is introduced into the cylinder head under pressure by means of a fuel injector just before top dead center of the compression stroke, and immediately before combustion.

FIG. 2 is a schematic illustration of the manner in which the spark injection system 30 would operate from an ignition magneto 40 which would provide a spark ignition to each particular cylinder by means of a coil 42 associated with each cylinder at the appropriate time since the strokes of each cylinder are staggered in order that a power stroke is always being provided to the crank shaft to maintain its rotation. The magneto 40 would be operated by a small electric motor 50 mounted to the engine and powered by the vehicles electrical system.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. The spark injection system for diesel engines in order to promote complete combustion, the spark injection system comprising:
an electrical spark contact positioned in the head of each cylinder of a diesel engine, said electrical contact and electrical communication with a coil which is in contact with a magneto for the generation of an electrical charge, said magneto operable by an electric motor, the initial fuel/air mixture within the diesel cylinder being ignited as the result of the combination of the heat of pressurization during the compression stroke, and an electrical spark discharge from said electrical spark contact thereby initiating the downward power stroke, said spark injection system introducing a spark into said diesel cylinder.

2. The spark injection system in accordance with claim 1 wherein the spark injection comprises intermittent pulses introduced into the cylinder head.

3. The spark injection system in accordance with claim 2 where in said intermittent pulses are pulsed in the range of from 50 to 100 pulses per second.

4. The spark injection system in accordance with claim 2 wherein said intermittent pulse is introduced continuously during the compression, power, exhaust, and intake stroke.

5. The spark injection system in accordance with claim 2 wherein said intermittent pulse is introduced into said cylinder head after top dead center of the power stroke and continuing during the exhaust stroke thereby completely detonating the entire fuel/air mixture within the diesel cylinder.

6. The spark injection system in accordance with claim 5 wherein said spark injection is introduced into said diesel cylinder no sooner than five degrees after top dead center of the compression stroke.

7. The spark injection system in accordance with claim 5 wherein the introduction of electrical spark into the diesel cylinder would cease when the exhaust stroke were three quarters completed.

8. The spark injection system in accordance with claim 7 wherein said intermittent pulses are pulsed in the range of from 50 to 100 pulses per second.
